(19) United States
(12) Patent Application Publication
(10) Pub. No.: US 2010/0286913 A1
(43) Pub. Date: Nov. 11, 2010

(54) System Including Two Combined Instruments and Method for Aligning Said System

(75) Inventor: Florent Colliau, Coulanges (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/744,247

(22) PCT Filed: Nov. 21, 2008
(86) PCT No.: PCT/EP2008/066031

§ 371 Date: Jul. 21, 2010

(30) Foreign Application Priority Data
Nov. 23, 2007 (FR) 0708217

(51) Int. Cl. G01C 21/16

(52) U.S. Cl. 701/220

(57) ABSTRACT

The invention relates to the instruments for aiding the piloting of aircraft and more precisely a system comprising two instruments (ICS1, ICS2) making it possible to display flight parameters and notably the attitude of the aircraft. Each instrument comprises an inertial measurement unit (121, 122). The invention makes it possible to align the inertial measurement units (121, 122) in a stand-alone manner even when the aircraft is in motion. The alignment can be carried out without using an external source of information. Accordingly, the alignment is carried out mutually for the two inertial measurement units (121, 122) based on a relative position of each instrument (ICS1, ICS2) and on measurements (Ω1, Ω2, γ1, γ2) taken by each instrument (ICS1, ICS2) during one and the same time period.

The invention relates to the instruments for aiding the piloting of aircraft. It relates more particularly but not exclusively to the stand-by instruments fitted to aircraft and designed to display essential navigation data in a redundant manner with the primary systems of the aircraft.

A combined stand-by instrument, (well known in the literature under the name of integrated electronics stand-by instrument) makes it possible to display flight parameters such as the attitude of the aircraft, its altitude and its speed and optionally a number of other data independently of the primary systems, in a more summary manner and with less precision. The information displayed is computed directly by the combined stand-by instrument which displays on one and the same screen, usually in color, all of the stand-by information. The sensors associated with the combined stand-by instrument such as pressure sensors for the measurement of total pressures Pt and static pressures Ps of the air surrounding the aircraft and an inertial measurement unit comprising, for example, gyrometers and accelerometers for the determination of the attitude of the aircraft are usually incorporated into this instrument. If the primary display system should fail, the pilot uses the data displayed on the combined stand-by instrument in order to pilot the aircraft. The display usually follows the same presentation as that of the primary systems.

To date, the instrument panels have only one combined stand-by instrument, even when the aircraft is piloted by two pilots. The combined stand-by instrument is placed in the center of the instrument panel and can be used by both pilots. With the appearance of very wide-bodied airplanes, the aircraft manufacturers wanted to place two combined stand-by instruments each of which could be used by one of the two pilots.

The attitude information is displayed in a frame of reference associated with the earth and is computed based on data originating from an inertial measurement unit present in the combined stand-by instrument. This inertial measurement unit comprises, for example, gyrometers and accelerometers sustaining an intrinsic drift and the rotation of the earth. An alignment phase of several tens of seconds is necessary for the start-up of the combined stand-by instrument in order to converge on a precise estimate of its drifts in order to subtract them from the measurements for the purpose of obtaining the attitude of the aircraft in the most accurate way possible.

A method of alignment used in the combined stand-by instruments consists in imposing the immobility of the instrument during this alignment phase so as not to induce errors of estimation of gyrometric drifts due to the movements of the aircraft. This method can be used when the aircraft is on the ground. In flight, if, for example, the aircraft sustains a power failure of its inertial measurement units, an alignment procedure consists in imposing a stabilized flight on the aircraft, which can be difficult to achieve. Moreover, any difference relative to a perfect stabilization is wrongly interpreted as a drift of the inertial measurement unit.

Another alignment method consists in using a source of external information for estimating any movements of the aircraft. But the need for the combined stand-by instrument to be stand-alone limits the possibility of using this external source. For example, this complicates the alignment of the combined stand-by instrument mounted onboard a helicopter onboard a ship, the movements of the ship preventing the stand-by instrument from being immobile.

The object of the invention is to alleviate some or all of the problems cited above by proposing to achieve an alignment of inertial measurement units without making use of a source of external information, even if the inertial measurement units are in motion in a coordinate system associated with the earth.

Accordingly, a subject of the invention is a system comprising two instruments mounted onboard an aircraft, and means for communication between the two instruments, each instrument comprising a stand-alone inertial measurement unit, characterized in that it also comprises means for mutual alignment of each inertial measurement unit based solely on the knowledge of the relative positions of each instrument and on measurements taken by the inertial measurement units during one and the same time period.

A further subject of the invention is a method of alignment of a system comprising two instruments mounted onboard an aircraft, and means for communication between the two instruments, each instrument comprising a stand-alone inertial measurement unit, characterized in that it consists in mutually aligning each inertial measurement unit based on a relative position of each instrument and on measurements taken by each instrument during one and the same time period.

The invention will be better understood and other advantages will appear on reading the detailed description of an embodiment given as an example, said description being illustrated by the attached drawing in which:

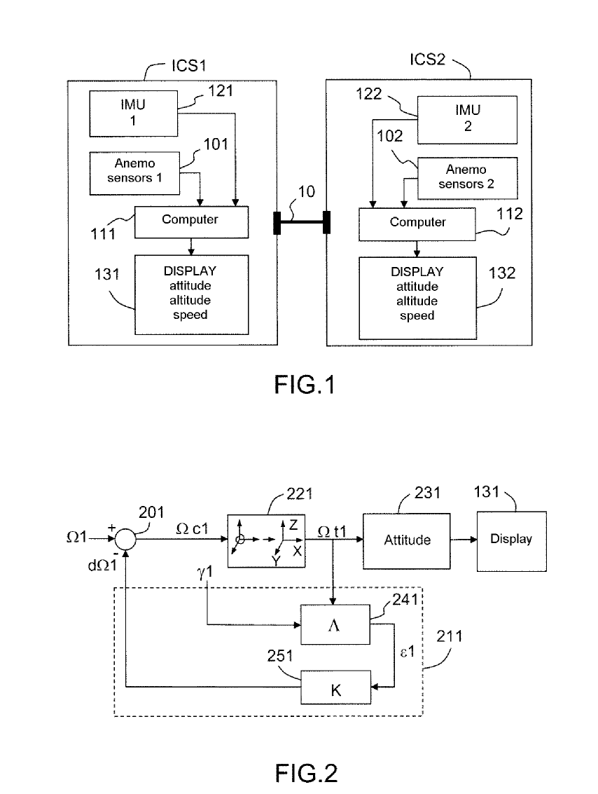

FIG. 1 represents a system comprising two combined stand-by instruments;

FIG. 2 represents schematically the determination of the attitude in a combined stand-by instrument;

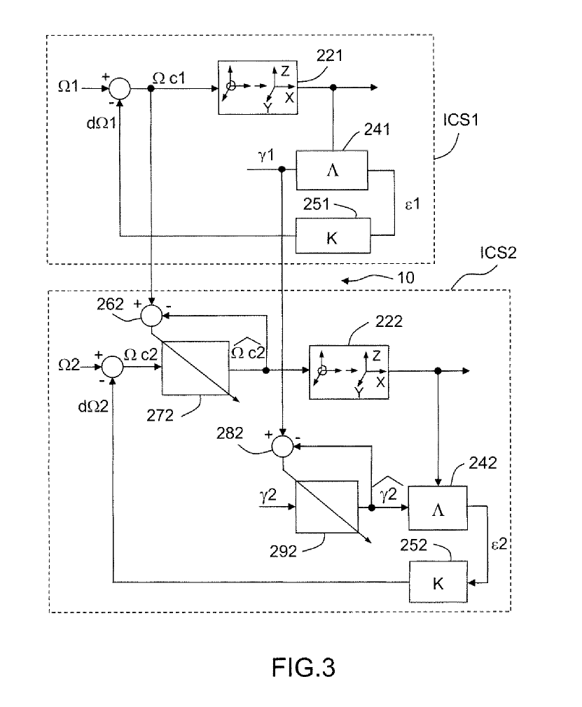

FIG. 3 illustrates an example of alignment according to the invention of the system shown in FIG. 1.

For the purposes of clarity, the same elements will bear the same reference numbers in the various figures.

The following description is made with reference to a system comprising two combined stand-by instruments. It is of course possible to apply the invention based on any system comprising two instruments each having an inertial measurement unit.

FIG. 1 represents a system comprising two combined stand-by instruments ICS1 and ICS2 designed to be fitted to the instrument panel of an aircraft. The system is usually used as a stand-by for a primary system also fitted to the instrument panel. It is also possible to use the system of FIG. 1, not as a stand-by system, but as a primary system in smaller-capacity aircraft. The instruments then on their own provide the redundancy of the sensors and of the display. The two instruments ICS1 and ICS2 are advantageously identical in order to improve the standardization of the equipment of the aircraft.

Each instrument ICS1 and ICS2 comprises anemo-barometric sensors 10i, i representing the number of the combined stand-by instrument ICS n⁰ 1 or ICS n⁰ 2. In the rest of the description, this convention will be used to distinguish the similar elements of the two combined stand-by instruments ICS1 and ICS2. The anemo-barometric sensors 101 and 102 are connected to pressure heads not shown in FIG. 1 and placed on the skin of the aircraft. The pressure heads and the anemo-barometric sensors 101 and 102 make it possible to determine the static pressure Ps and the total pressure Pt of the air surrounding the aircraft. From these pressures, the combined instrument ICS1 or ICS2 determines by means of a computer, respectively 111 and 112, the altitude and the speed of the aircraft.

Each combined stand-by instrument ICS1 and ICS2 also comprises an inertial measurement unit 12i. The inertial measurement units 121 and 122 may comprise accelerometers and gyrometers. The inertial measurement units 121 and 122 allow the combined instrument ICS1 or ICS2 to determine the attitude of the aircraft.

The altitude, the speed, and the attitude of the aircraft form the flight parameters of the aircraft. The inertial measurement units 121 and 122 and the anemo-barometric sensors 101 and 102 and the associated computers 111 and 112 form means for determining the flight parameters. These determination means are stand-alone because they belong to the combined stand-by instrument in question and can operate with no other external information than that originating from the pressure heads.

Each combined stand-by instrument ICS1 and ICS2 comprises means, respectively 131 and 132, for displaying the flight parameters. The attitude is usually displayed in the form of a movable horizon line relative to a fixed silhouette representing the aircraft. Each combined stand-by instrument ICS1 and ICS2 can also display navigation parameters containing information on the route that the aircraft must follow. This information is received from other systems fitted to the instrument panel such as for example an automatic pilot of the aircraft. In a system comprising two combined stand-by instruments ICS1 and ICS2, one of the instruments may display the flight parameters and the other the navigation parameters.

The system comprises means 10 for communication between the two combined stand-by instruments ICS1 and ICS2 using, for example, a serial link produced by means of an electric conductor linking the two combined stand-by instruments ICS1 and ICS2. The data transfer protocol uses a digital data transmission standard. The communication means 10 make it possible, for example, to interchange information on the display of the two combined stand-by instruments ICS1 and ICS2, for example in order to prevent the two instruments from displaying the same information, flight parameters or navigation parameters. The communication means 10 are also used to apply the invention and interchange between the two combined stand-by instruments ICS1 and ICS2 information allowing their mutual alignment.

FIG. 2 represents schematically the determination of the attitude in a combined stand-by instrument, in this instance ICS1. It is naturally possible to proceed in the same manner for the combined stand-by instrument ICS2. Gyrometers of the inertial measurement unit 121 deliver information marked Ω1 comprising angular speeds on three axes and sustained by the combined stand-by instrument ICS1. The information Ω1 is corrected by means of an operator 201 of the drifts inside the inertial measurement unit and of the rotation of the earth. Subsequently, the rotation of the earth and the drift will be assimilated and these two combined parameters will be marked dΩ1. Means 211 for determining the drift dΩ1 will be described below. To the information thus corrected and marked Ωc1, a change of coordinate system 221 is applied making it possible to switch from a coordinate system associated with the gyrometers to a terrestrial coordinate system. After this change of coordinate system, the information Ωt1 is used to determine at the coordinate system 231 the attitude of the aircraft which is displayed on the display means 131.

The operator 201 receives the information Ω1 from which it subtracts the drift dΩ1 generated by the means 211 based on the information Ωt1 and from an item of information γ1 originating from accelerometers belonging to the inertial measurement unit 121. The information γ1 associated with the information Ωt1 makes it possible to determine, at the coordinate system 241, an error ε1 which is for example filtered by means of a Kalman filter and then integrated in order to determine the drift dΩ1. The filtering and the integration are shown at coordinate system 251.

The operations described in FIG. 2 do not make it possible to initialize the drift dΩ1 if the combined stand-by instrument ICS1 is in motion. More precisely, the gyrometers measure the motion of the aircraft combined with the rotation of the earth and the drift of the gyrometers. By using a method as described with the aid of FIG. 1, using only one combined stand-by instrument, distinguishing between the motion of the aircraft and the other two parameters which are the drift and the rotation of the earth becomes difficult.

According to the invention, the inertial measurement units of each combined stand-by instrument ICS1 and ICS2 are mutually aligned based on a relative position of each instrument and of measurements taken by each instrument during one and the same time period. FIG. 3 illustrates an example of means for carrying out this alignment and the associated method. In order to prevent overloading FIG. 3, only the means for aligning the combined stand-by instrument ICS2 have been shown. By symmetry, by reversing the means and information relating to the two combined stand-by instruments, it is easy to find out how to apply the invention for the combined stand-by instrument ICS1.

Advantageously, the combined stand-by instrument ICS2 comprises means for converting the measurements taken by the inertial measurement unit 122 in order to bring them to the location of the combined stand-by instrument ICS1 and means for subtraction 262 between the measurement Ω1 taken by the combined stand-by instrument ICS1 and the measurement taken by the combined stand-by instrument ICS2 after conversion and marked [symbol] More precisely, the combined stand-by instrument ICS2 comprises an adaptive filter 272 the parameters of which are adapted according to a result originating from the subtraction means 262. The adaptive filter 272 converts the information Ωc2 measured by the combined stand-by instrument ICS2 and corrected for the drift dΩ2 in order to bring it to the location of the combined stand-by instrument ICS1. Parameters of the adaptive filter 272 are adapted according to the result of the subtraction made by the subtraction means 262. The value of the measurement [symbol] after conversion is a value estimated by the adaptive filter 272 because of a possible misalignment of the two inertial measurement units 121 and 122. The conversion, for its part, is only a function of the relative position of the two combined stand-by instruments ICS1 and ICS2 and more precisely of the relative position of the inertial measurement units 121 and 122. To choose the optimal adaptive filter, it is possible to use the Wiener filtering theory. The estimated value [symbol] is used as an input to the means for changing coordinate system 222.

In the same way, the combined stand-by instrument ICS2 comprises means for converting measurements γ2 taken by the accelerometers of the combined stand-by instrument ICS2 in order to bring them to the location of the combined stand-by instrument ICS1 and subtraction means 282 between the measurement γ1 taken by the combined stand-by instrument ICS1 and the measurement taken by the combined stand-by instrument ICS2 after conversion and marked [symbol] Here again, this is an estimated value. Accordingly, the combined stand-by instrument ICS2 comprises an adaptive filter 292 the parameters of which are adapted according to a result originating from the subtraction means 282. The estimated value [symbol] is used as an input to the means for determining the error ε2.

For the alignment, the measurements taken by the two combined stand-by instruments ICS1 and ICS2 are taken during one and the same time period in order to avoid a possible motion occurring between the two measurements taken by each of the combined stand-by instruments ICS1 and ICS2. Advantageously, the system comprises means for synchronizing the measurements taken by the two combined stand-by instruments ICS1 and ICS2. Synchronizing the measurements of the two series prevents any common mode disturbance that may occur. The synchronization is all the more useful if adaptive filters, using discrete measurements, are put in place. The filters of the two combined stand-by instruments ICS1 and ICS2 then work in parallel and simultaneously in order to converge rapidly on the alignment of the inertial measurement units 121 and 122. In other words, several measurements Ω1 and γ1 are taken with the aid of the combined stand-by instrument ICS1 and several measurements Ω2 and γ2 with the aid of the combined stand-by instrument ICS2 and sampled over one and the same time period. Each measurement Ω1 is synchronized with a measurement γ1 and each measurement Ω2 is synchronized with a measurement γ2.

1. A system comprising two instruments mounted onboard an aircraft, and means for communication between the two instruments, each instrument comprising a stand-alone inertial measurement unit, sustaining drifts comprising an intrinsic drift and the rotation of the earth, means for mutual alignment of each inertial measurement unit based solely on the knowledge of a relative position of each instrument and on measurements taken by the inertial measurement units during one and the same time period, and in that the alignment of each instrument consists in a convergence on a precise estimate of the drifts of each one in order to subtract it from the inertial measurements.

2. The system as claimed in claim 1, wherein each instrument comprises means for converting the measurements taken by one of the instruments in order to bring them to the location of the other instrument and means for subtraction between the measurement taken by one of the instruments and the measurement taken by the other instrument after conversion.

3. The system as claimed in claim 2, wherein each instrument comprises an adaptive filter the parameters of which are adapted according to a result originating from the subtraction means.

4. The system as claimed in claim 1, further comprising means for synchronizing the measurements taken by the two instruments.

5. The system as claimed in claim 1, wherein the instruments are stand-by instruments of the aircraft.

6. The system as claimed in claim 1, wherein the instruments are identical.

7. A method of alignment of a system comprising two instruments mounted onboard an aircraft, and means for communication between the two instruments, each instrument comprising a stand-alone inertial measurement unit, sustaining drifts comprising an intrinsic drift and the rotation of the earth, the method comprising mutually aligning each inertial measurement unit based on a relative position of each instrument and on measurements taken by each instrument during one and the same time period and in that the alignment of each instrument consists in a convergence on a precise estimate of the drifts of each one in order to subtract it from the inertial measurements.

8. The method as claimed in claim 7, further comprising symmetrically aligning each of the instruments by subtracting from a first inertial measurement taken by one of the instruments, a second inertial measurement taken by the other instrument, the second measurement being brought to the location of the first measurement.

9. The method as claimed in claim 8, further comprising using an adaptive filter to bring the first measurement to the location of the second measurement, parameters of the adaptive filter being adapted according to the result of the subtraction.

10. The method as claimed in claim 8, further comprising taking several first measurements and several second measurements sampled over the time period and in that each first measurement is synchronized with a second measurement.
